(19) United States
(12) Patent Application Publication
(10) Pub. No.: US 2011/0095977 A1
(43) Pub. Date: Apr. 28, 2011

(54) INTERACTIVE INPUT SYSTEM INCORPORATING MULTI-ANGLE REFLECTING STRUCTURE

(75) Inventor: CHARLES UNG, Calgary (CA)

(73) Assignee: SMART Technologies ULC, Calgary (CA)

(21) Appl. No.: 12/604,505

(22) Filed: Oct. 23, 2009

(51) Int. Cl. G06F 3/033

(52) U.S. Cl. 345/158

(57) ABSTRACT

An interactive input system comprises at least one imaging device having a field of view looking into a region of interest. At least one radiation source emits radiation into the region of interest. A bezel at least partially surrounds the region of interest. The bezel comprises a multi-angle reflecting structure to reflect emitted radiation from the at least one radiation source towards the at least one imaging device.

### FIELD OF THE INVENTION

The present invention relates generally to interactive input systems and in particular, to an interactive input system incorporating multi-angle reflecting structure.

### BACKGROUND OF THE INVENTION

Interactive input systems that allow users to inject input (eg. digital ink, mouse events etc.) into an application program using an active pointer (eg. a pointer that emits light, sound or other signal), a passive pointer (eg. a finger, cylinder or other suitable object) or other suitable input device such as for example, a mouse or trackball, are known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 assigned to SMART Technologies ULC of Calgary, Alberta, Canada, assignee of the subject application, the contents of which are incorporated by reference; touch systems comprising touch panels employing electromagnetic, capacitive, acoustic or other technologies to register pointer input; tablet personal computers (PCs); touch-enabled laptop PCs; personal digital assistants (PDAs); and other similar devices.

Above-incorporated U.S. Pat. No. 6,803,906 to Morrison et al. discloses a touch system that employs machine vision to detect pointer interaction with a touch surface on which a computer-generated image is presented. A rectangular bezel or frame surrounds the touch surface and supports digital cameras at its corners. The digital cameras have overlapping fields of view that encompass and look generally across the touch surface. The digital cameras acquire images looking across the touch surface from different vantages and generate image data. Image data acquired by the digital cameras is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

To enhance the ability to detect and recognize passive pointers brought into proximity of a touch surface in touch systems employing machine vision technology, it is known to employ illuminated bezels to illuminate evenly the region over the touch surface. For example, U.S. Pat. No. 6,972,401 to Akitt et al. issued on Dec. 6, 2005 and assigned to SMART Technologies ULC, discloses an illuminated bezel for use in a touch system such as that described in above-incorporated U.S. Pat. No. 6,803,906. The illuminated bezel emits infrared red or other suitable radiation over the touch surface that is visible to the digital cameras. As a result, in the absence of a passive pointer in the fields of view of the digital cameras, the illuminated bezel appears in captured images as continuous bright or “white” band. When a passive pointer is brought into the fields of view of the digital cameras, the passive pointer occludes emitted radiation and appears as a dark region interrupting the bright or “white” band in captured images allowing the existence of the pointer in the captured images to be readily determined and its position triangulated. Although this illuminated bezel is effective, it is expensive to manufacture and can add significant cost to the overall touch system. It is therefore not surprising that alternative techniques to illuminate the region over touch surfaces have been considered.

For example, U.S. Pat. No. 7,283,128 to Sato discloses a coordinate input apparatus including light-receiving unit arranged in the coordinate input region, a retroreflecting unit arranged at the peripheral portion of the coordinate input region to reflect incident light and a light-emitting unit which illuminates the coordinate input region with light. The retroreflecting unit is a flat tape and includes a plurality of triangular prisms each having an angle determined to be equal to or less than the detection resolution of the light-receiving unit. Angle information corresponding to a point which crosses a predetermined level in a light amount distribution obtained from the light receiving unit is calculated. The coordinates of the pointer position are calculated on the basis of a plurality of pieces of calculated angle information, the angle information corresponding to light emitted by the light-emitting unit that is reflected by the pointer.

Although the use of the retroreflecting unit to reflect and direct light into the coordinate input region is less costly than employing illuminated bezels, problems with such a retroreflecting unit exist. The amount of light reflected by the retroreflecting unit is dependent on the incident angle of the light. As a result, the Sato retroreflecting unit works best when the light is normal to its retroreflecting surface. However, when the angle of incident light on the retroreflecting surface becomes larger, the performance of the retroreflecting unit degrades resulting in uneven illumination of the coordinate input region. As a result, the possibility of false pointer contacts and/or missed pointer contacts is increased. As will be appreciated, improvements in illumination for machine vision interactive input systems are desired.

It is therefore an object of the present invention to provide a novel interactive input system incorporating multi-angle reflecting structure.

### SUMMARY OF THE INVENTION

Accordingly, in one aspect there is provided an interactive input system comprising at least one imaging device having a field of view looking into a region of interest, at least one radiation source emitting radiation into said region of interest and a bezel at least partially surrounding said region of interest, said bezel comprising a multi-angle reflecting structure to reflect emitted radiation from said at least one radiation source towards said at least one imaging device.

In one embodiment, the multi-angle reflecting structure comprises at least one series of reflective elements extending along the bezel. The reflective elements are configured to reflect emitted radiation from the at least one radiation source towards the at least one imaging device. Each reflective element is of a size smaller than the pixel resolution of the at least one imaging device and presents a reflective surface that is angled to reflect emitted radiation from the at least one radiation source towards the at least one imaging device. The reflecting surface may be generally planar, generally convex, or generally concave. The configuration of the reflective surfaces may also vary over the length of the bezel.

In one embodiment, the at least one radiation source is positioned adjacent the at least one imaging device and emits non-visible radiation such as for example infrared radiation. In this case, the at least one radiation source comprises one or more infrared light emitting diodes.

In one embodiment, the bezel comprises a backing and a film on the backing with the film being configured by machining and engraving to form the multi-angle reflecting structure.

In one embodiment, the interactive input system comprises at least two imaging devices with the imaging devices looking into the region of interest from different vantages and having overlapping fields of view. Each section of the bezel seen by an imaging device comprises a multi-angle reflecting structure to reflect emitted radiation from the at least one radiation source towards that imaging device. Each section of the bezel seen by more than one imaging device comprises a multi-angle reflecting structure for each imaging device. The interactive input system may further comprise processing structure communicating with the imaging devices and processing image data output thereby to determine the location of a pointer within the region of interest.

According to another aspect there is provided a bezel for an interactive touch surface comprising a multi-angled reflector comprising at least one series of reflective surfaces extending along the bezel, each reflecting surface being oriented to reflect radiation toward at least one imaging device.

### BRIEF DESCRIPTION OF THE DRAWINGS

Embodiments will now be described more fully with reference to the accompanying drawings in which:

FIG. 1 is a schematic diagram of an interactive input system;

FIG. 2 is a schematic diagram of an imaging assembly forming part of the interactive input system of FIG. 1;

FIG. 3 is a schematic diagram of a master controller forming part of the interactive input system of FIG. 1;

FIG. 4 is a front elevational view of an assembly forming part of the interactive input system of FIG. 1 showing the fields of view of imaging devices across a region of interest;

FIG. 5A is a front elevational view of a portion of the assembly of FIG. 4 showing a bezel segment comprising a multi-angle reflector;

FIGS. 5B and 5C are top plan and front elevation views of the multi-angle reflector shown in FIG. 5A;

FIG. 6 is an enlarged view of a portion of FIG. 1 showing a portion of another bezel segment forming part of the assembly of FIG. 4;

FIG. 7 is an isometric view of the bezel segment portion of FIG. 6;

FIG. 8 is a top plan view of the bezel segment portion of FIG. 7;

FIGS. 9A and 9B are top plan and front elevation views of a multi-angle reflector forming part of the bezel segment portion of FIG. 7;

FIGS. 9C and 9D are top plan and front elevation views of another multi-angle reflector forming part of the bezel segment portion of FIG. 7;

FIG. 10A is a front elevation view of the bezel segment portion of FIG. 7;

FIGS. 10B and 10C are front elevation views of alternative bezel segments;

FIGS. 10D and 10E are isometric and top plan views of yet another bezel segment;

FIG. 11A is a schematic diagram of an alternative assembly for use in an interactive input system;

FIG. 11B is a schematic diagram of an equivalent assembly to that shown in FIG. 11A;

FIG. 12 is a schematic diagram of yet another assembly for use in an interactive input system;

FIGS. 13A and 13B are top plan and front elevation views of a multi-angle reflector employed in the assembly of FIG. 12;

FIGS. 13C and 13D are top plan and front elevation views of another multi-angle reflector employed in the assembly of FIG. 12; and

FIG. 14 is an isometric view of a laptop computer embodying a multi-angle reflector.

### DETAILED DESCRIPTION OF THE PREFERRED EMBODIMENTS

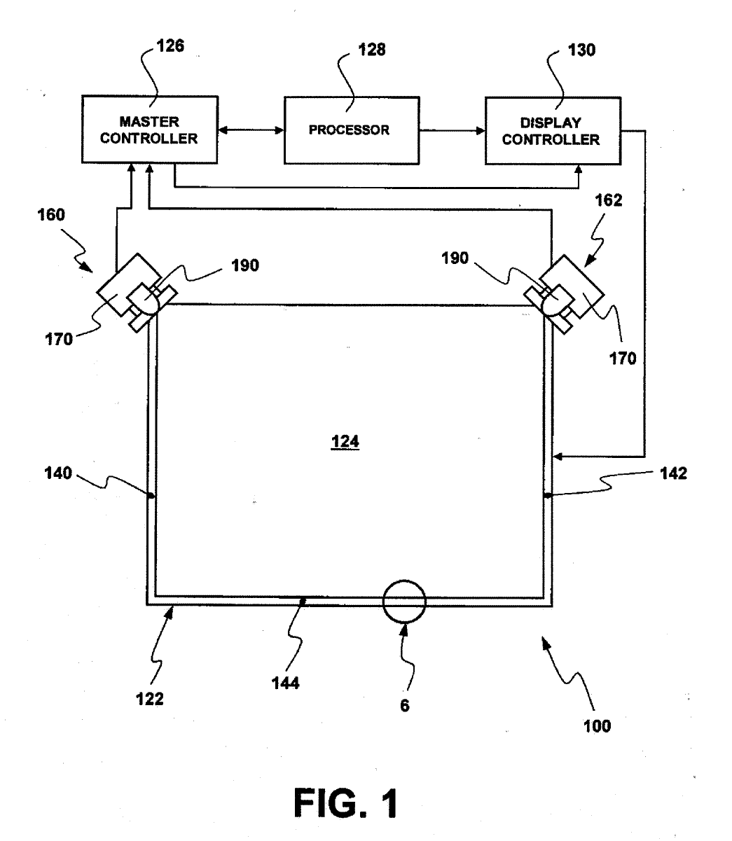

Turning now to FIG. 1, an interactive input system that allows a user to inject input such as digital ink, mouse events etc. into an application program is shown and is generally identified by reference numeral 100. In this embodiment, interactive input system 100 comprises an assembly 122 that engages a display unit (not shown) such as for example, a plasma television, a liquid crystal display (LCD) device, a flat panel display device, a cathode ray tube display or monitor etc. and surrounds the display surface 124 of the display unit. The assembly 122 employs machine vision to detect pointers brought into proximity with the display surface 124 and communicates with a master controller 126. The master controller 126 in turn communicates with a general purpose computing device 128 executing one or more application programs. General purpose computing device 128 processes the output of the assembly 122 and provides display output to a display controller 130. Display controller 130 controls the image data that is fed to the display unit so that the image presented on the display surface 124 reflects pointer activity. In this manner, the assembly 122, master controller 126, general purpose computing device 128 and video controller 130 allow pointer activity proximate to the display surface 124 to be recorded as writing or drawing or used to the control execution of one or more application programs executed by the general purpose computing device 128.

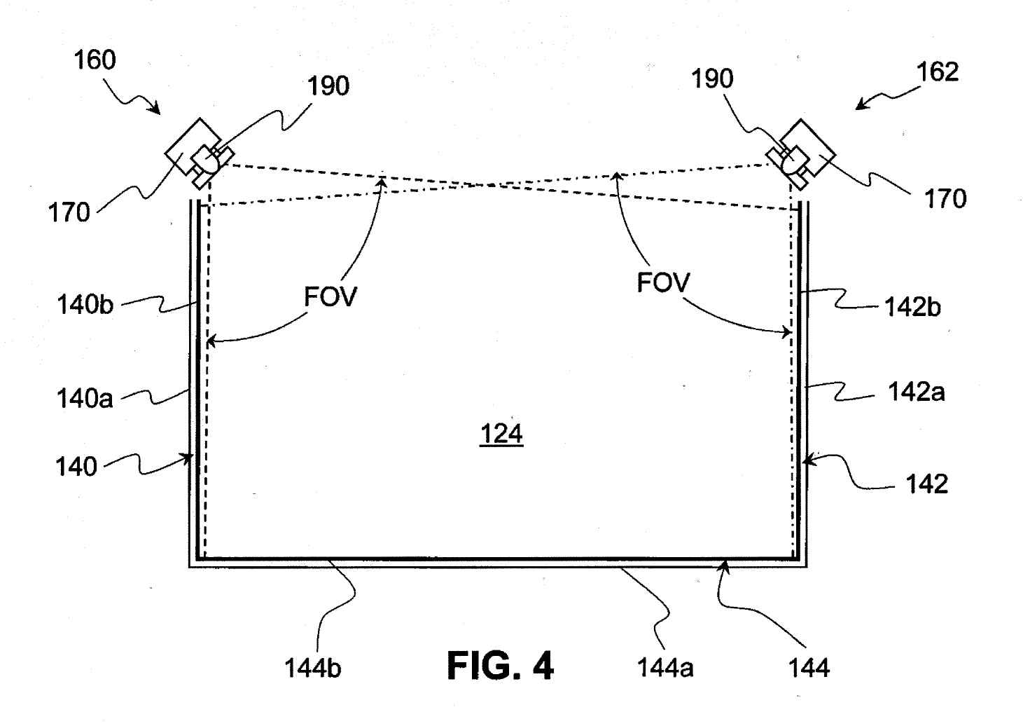

Assembly 122 comprises a frame assembly that is mechanically attached to the display unit and surrounds the display surface 124. Frame assembly comprises a bezel having three bezel segments 140, 142 and 144. Bezel segments 140 and 142 extend along opposite side edges of the display surface 124 while bezel segment 144 extends along the bottom edge of the display surface 124. Imaging assemblies 160 and 162 are positioned adjacent the top left and top right corners of the assembly 122 and are oriented so that their fields of view (FOV) overlap and look generally across the entire display surface 124 as shown in FIG. 4. The bezel segments 140, 142 and 144 are oriented so that their inwardly facing surfaces are generally normal to the plane of the display surface 124. In this embodiment, imaging assembly 160 sees bezel segments 142 and 144 and imaging assembly 162 sees bezel segments 140 and 144. Thus, the bottom bezel segment 144 is seen by both imaging assemblies 160 and 162 while the bezel segments 140 and 142 are only seen by one imaging assembly.

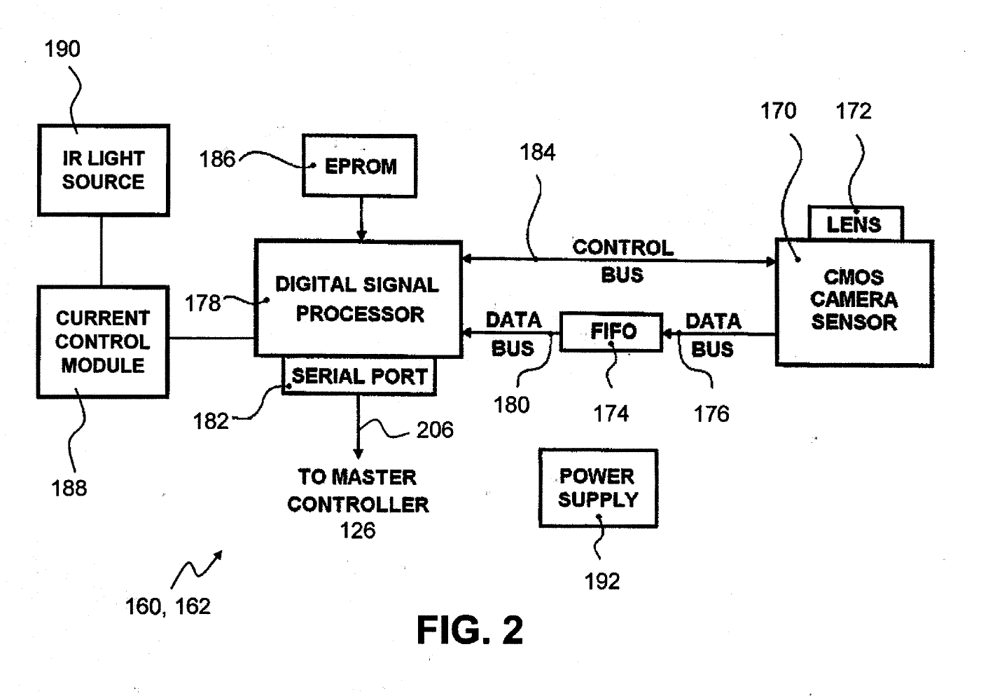

Turning now to FIG. 2, one of the imaging assemblies 160, 162 is better illustrated. As can be seen, the imaging assembly comprises an image sensor 170 such as that manufactured by Micron Technology, Inc. of Boise, Id. under model no. MT9V022 fitted with an 880 nm lens 172 of the type manufactured by Boowon Optical Co. Ltd. under model no. BW25B. The lens 172 provides the image sensor 170 with a 98 degree field of view so that the entire display surface 124 is seen by the image sensor. The image sensor 170 communicates with and outputs image frame data to a first-in first-out (FIFO) buffer 174 via a data bus 176. A digital signal processor (DSP) 178 receives the image frame data from the FIFO buffer 174 via a second data bus 180 and provides pointer data to the master controller 126 via a serial input/output port 182 when a pointer exists in image frames captured by the image sensor 170. The image sensor 170 and DSP 178 also communicate over a bi-directional control bus 184. An electronically programmable read only memory (EPROM) 186 which stores image sensor calibration parameters is connected to the DSP 178. A current control module 188 is also connected to the DSP 178 as well as to an infrared (IR) light source 190 comprising one or more IR light emitting diodes (LEDs). The configuration of the LEDs of the IR light source 190 is selected to generally evenly illuminate the bezel segments in field of view of the imaging assembly. The imaging assembly components receive power from a power supply 192.

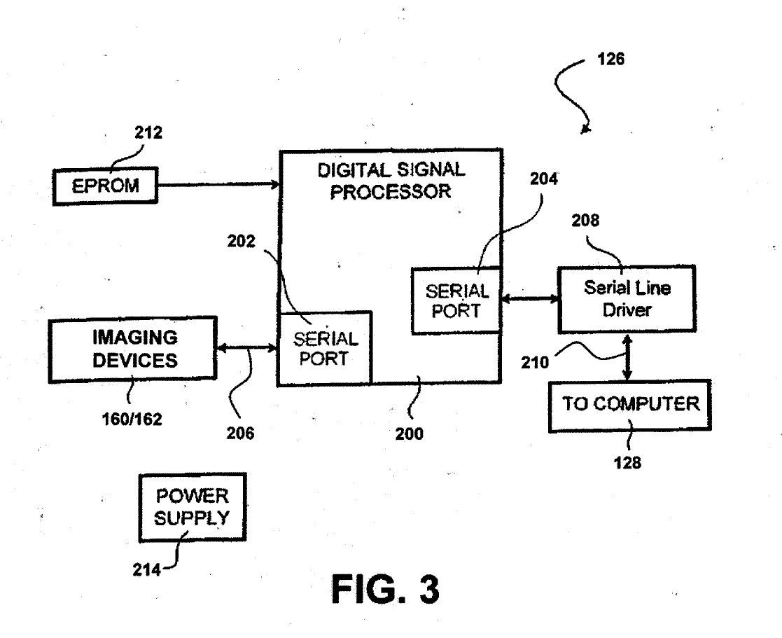

FIG. 3 better illustrates the master controller 126. Master controller 126 comprises a DSP 200 having a first serial input/output port 202 and a second serial input/output port 204. The master controller 126 communicates with imaging assemblies 160 and 162 via first serial input/output port 20 over communication lines 206. Pointer data received by the DSP 200 from the imaging assemblies 160 and 162 is processed by DSP 200 to generate pointer location data as will be described. DSP 200 communicates with the general purpose computing device 128 via the second serial input/output port 204 and a serial line driver 208 over communication lines 210. Master controller 126 further comprises an EPROM 212 that stores interactive input system parameters. The master controller components receive power from a power supply 214.

The general purpose computing device 128 in this embodiment is a computer comprising, for example, a processing unit, system memory (volatile and/or non-volatile memory), other non-removable or removable memory (eg. a hard disk drive, RAM, ROM, EEPROM, CD-ROM, DVD, flash memory, etc.) and a system bus coupling the various computer components to the processing unit. The computer can include a network connection to access shared or remote drives, one or more networked computers, or other networked devices.

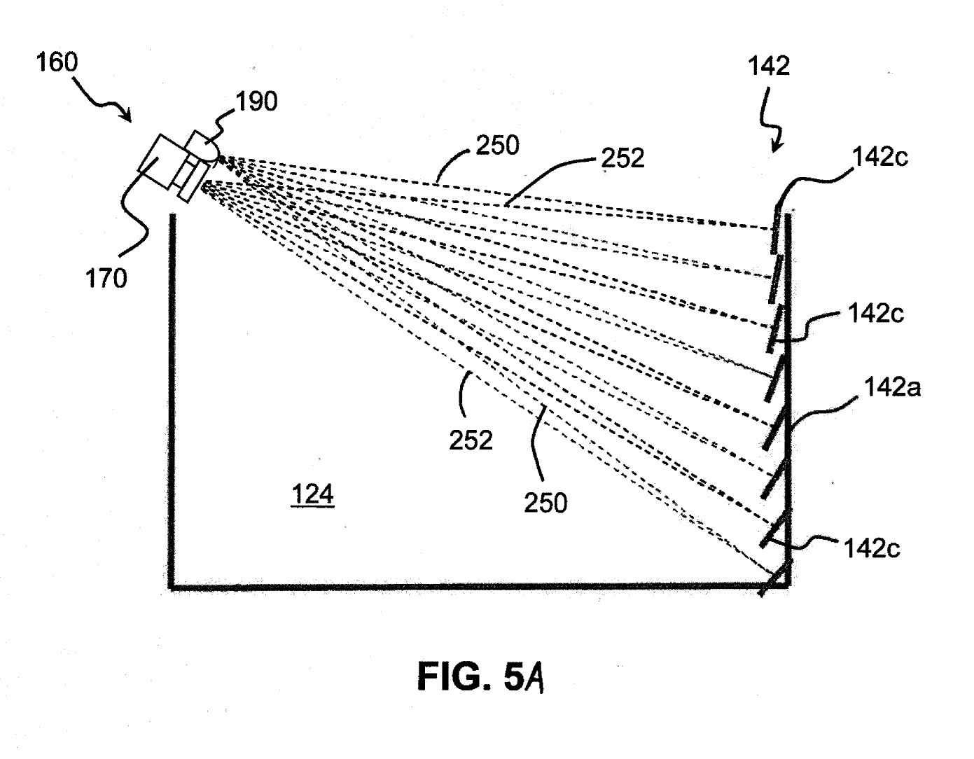

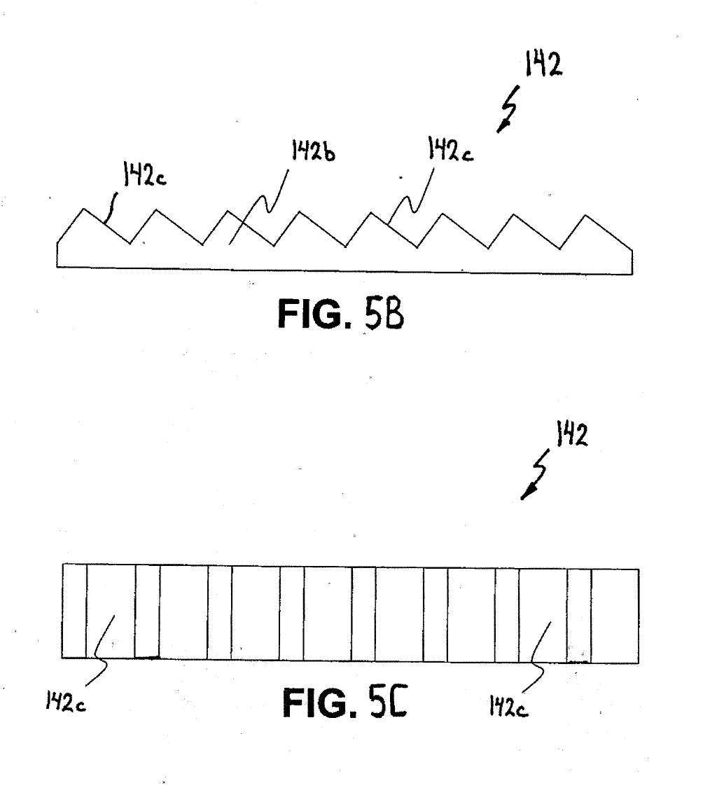

FIG. 5A shows the bezel segment 142 that is seen by the imaging assembly 160. In this embodiment as best illustrated in FIGS. 4, 5A, 5B and 5C, bezel segment 142 comprises a backing 142a having an inwardly directed surface on which a plastic film 142b is disposed. The plastic film 142b is machined and engraved to form a faceted multi-angle reflector. The facets of the multi-angle reflector define a series of highly reflective, generally planar mirror elements 142c extending along the length of the plastic film. The angle of each minor element 142c is selected so that light emitted by the IR light source 190 of imaging assembly 160 indicated by dotted lines 250 is reflected back towards the image sensor 170 of imaging assembly 160 as indicated by dotted lines 252. The size of each mirror element 142c is also selected so that it is smaller than the pixel resolution of the image sensor 170 of the imaging assembly 160. In this embodiment, the mirror elements 142c are in the sub-micrometer range. In this manner, the mirror elements 142c do not reflect discrete images of the IR light source 190 back to the image sensor 170. Forming microstructures, such as the mirror elements 142c, on plastic film 142b is a well known technology. As a result, the multi-angle reflector can be formed with a very high degree of accuracy and at a reasonably low cost.

The bezel segment 140 is a mirror image of bezel segment 142 and similarly comprises a backing 140a having a machined and engraved plastic film 140b on its inwardly directed surface that forms a faceted multi-angle reflector. The facets of the multi-angle reflector define a series of highly reflective, generally planar mirror elements extending along the length of the plastic film. In this case however, the angle of each mirror element is selected so that light emitted by the IR light source 190 of imaging assembly 162 is reflected back towards the image sensor 170 of imaging assembly 162.

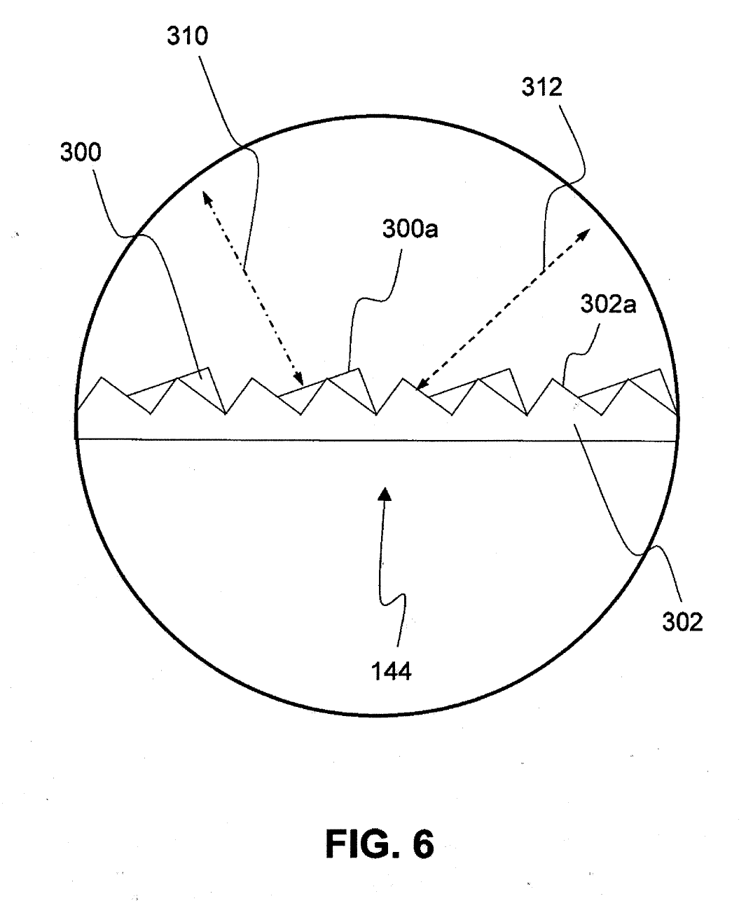

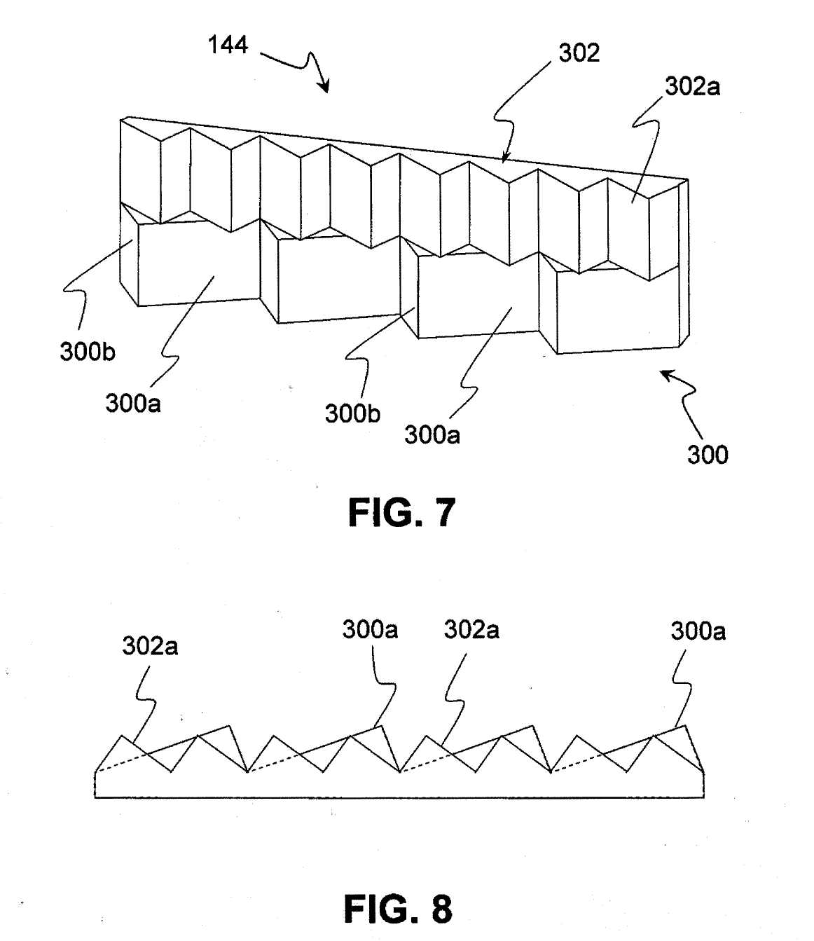

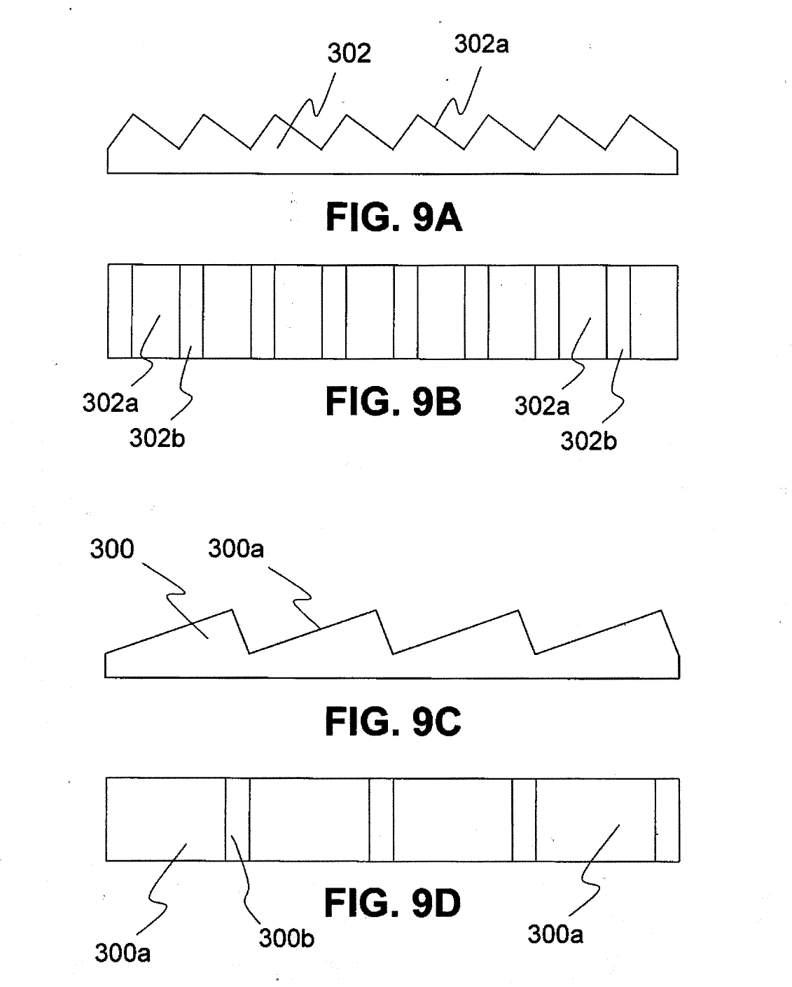

Bezel segment 144 that is seen by both imaging assemblies 160 and 162 has a different configuration than bezel segments 140 and 142. Turning now to FIGS. 4 and 6 to 10A, the bezel segment 144 is better illustrated. As can be seen, bezel segment 144 comprises a backing 144a having an inwardly directed surface that is generally normal to the plane of the display surface 124. Plastic film bands 144b positioned one above the other are disposed on the backing 144a. The bands may be formed on a single plastic strip disposed on the backing 144a or may be formed on individual strips disposed on the backing. In this embodiment, the plastic film band positioned closest to the display surface 124 is machined and engraved to form a faceted multi-angle reflector 300 that is associated with the imaging assembly 162. The other plastic film band is machined and engraved to form a faceted multi-angle reflector 302 that is associated with the imaging assembly 160.

The facets of the multi-angle reflector 300 define a series of highly reflective, generally planar mirror elements 300a that are angled to reflect lighted emitted by the IR light source 190 of the imaging assembly 162 towards the image sensor 170 of the imaging assembly 162 as indicated by dotted lines 310. The faces 300b of the multi-angle reflector 300 that are seen by the imaging assembly 160 are configured to reduce the amount of light that is reflected by the faces 300b back towards the imaging assembly 160. For example, the faces 300b may be coated with a non-reflective coating such as paint, textured to reduce their reflectivity etc. Similar to bezel segments 140 and 142, the size of each mirror element 300a is selected so that it is smaller than the pixel resolution of the image sensor 170 of the imaging assembly 162.

The facets of the multi-angle reflector 302 also define a series of highly reflective, generally planar mirror elements 302a that are angled to reflect lighted emitted by the IR light source 190 of the imaging assembly 160 towards the image sensor 170 of the imaging assembly 160 as indicated by dotted lines 312. The faces 302b of the multi-angle reflector 302 that are seen by the imaging assembly 162 are similarly configured to reduce the amount of light that is reflected by the faces 302b back towards the imaging assembly 162. For example, the faces 302b may be coated with a non-reflective coating such as paint, textured to reduce their reflectivity etc. The size of each minor element 302a is selected so that it is smaller than the pixel resolution of the image sensor 170 of the imaging assembly 162.

During operation, the DSP 178 of each imaging assembly 160, 162 generates clock signals so that the image sensor 170 of each imaging assembly captures image frames at the desired frame rate. The DSP 178 also signals the current control module 188 of each imaging assembly 160, 162. In response, each current control module 188 connects its associated IR light source 190 to the power supply 192. When the IR light sources 190 are on, each LED of the IR light sources 190 floods the region of interest over the display surface 124 with infrared illumination. For imaging assembly 160, infrared illumination emitted by its IR light source 190 that impinges on the minor elements 142c of the bezel segment 142 and on the mirror elements 302a of bezel segment 144 is returned to the image sensor 170 of the imaging assembly 160. As a result, in the absence of a pointer P within the field of view of the image sensor 170, the bezel segments 142 and 144 appear as a bright “white” band having a substantially even intensity over its length in image frames captured by the imaging assembly 160. Similarly, for imaging assembly 162, infrared illumination emitted by its IR light source 190 that impinges on the minor elements 140c of the bezel segment 140 and on the minor elements 300a of bezel segment 144 is returned to the image sensor 170 of the imaging assembly 162. As a result, in the absence of a pointer P within the field of view of the image sensor 170, the bezel segments 140 and 144 appear as a bright “white” band having a substantially even intensity over its length in image frames captured by the imaging assembly 162.

When a pointer is brought into proximity with the display surface 124, the pointer occludes infrared illumination and as a result, a dark region interrupting the bright band that represents the pointer, appears in image frames captured by the imaging assemblies 160, 162.

Each image frame output by the image sensor 170 of each imaging assembly 160, 162 is conveyed to the DSP 178. When the DSP 178 receives an image frame, the DSP 178 processes the image frame to detect the existence of a pointer therein and if a pointer exists, generates pointer data that identifies the position of the pointer within the image frame. The DSP 178 then conveys the pointer data to the master controller 126 via serial port 182 and communication lines 206.

When the master controller 126 receives pointer data from both imaging assembles 160 and 162, the master controller calculates the position of the pointer in (x,y) coordinates relative to the display surface 124 using well known triangulation such as that described in above-incorporated U.S. Pat. No. 6,803,906 to Morrison et al. The calculated pointer position is then conveyed by the master controller 126 to the general purpose computing device 128. The general purpose computing device 128 in turn processes the received pointer position and updates the image output provided to the video controller 130, if required, so that the image presented on the display surface 124 can be updated to reflect the pointer activity. In this manner, pointer interaction with the display surface 124 can be recorded as writing or drawing or used to control execution of one or more application programs running on the general purpose computing device 128.

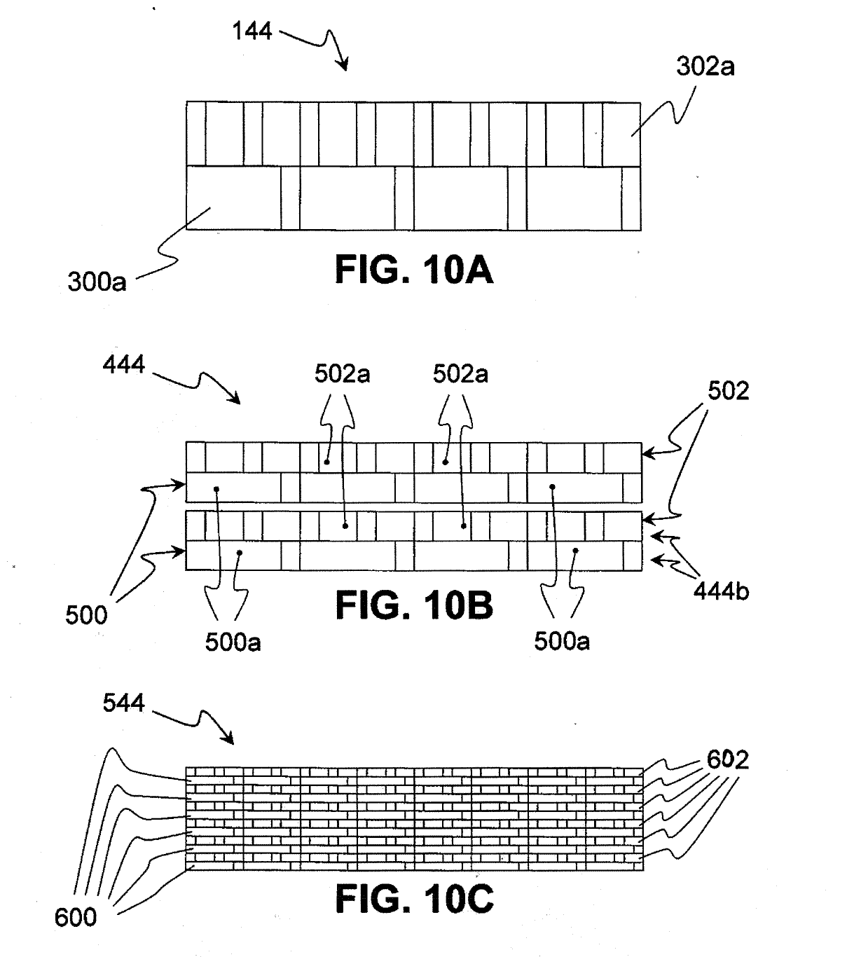

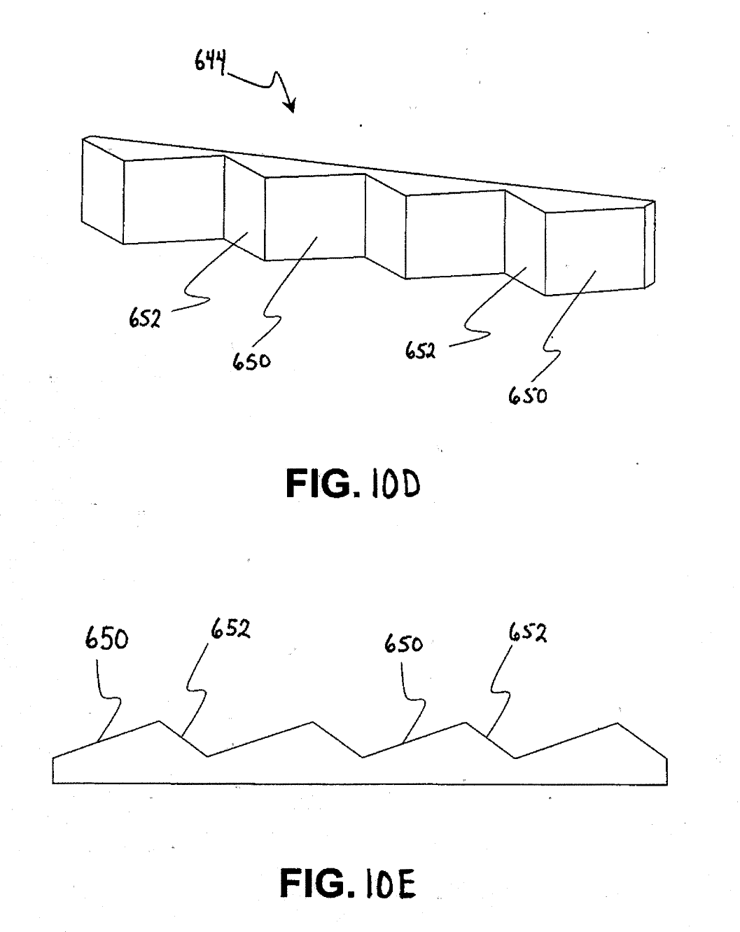

Although the bezel segment 144 is described above as including two bands positioned one above the other, alternatives are available. For example, FIG. 10B shows an alternative bezel segment 444 comprising a backing having an inwardly directed surface that is generally normal to the plane of the display surface 124. Four plastic film bands 444b positioned one above the other are disposed on the backing. The bands may be formed on a single plastic strip disposed on the backing or may be formed on individual strips disposed on the backing. In this embodiment, the odd plastic film bands, when starting with the plastic band positioned closest to the display surface 124, are machined and engraved to form faceted multi-angle reflectors 500 that are associated with the imaging assembly 162. The even plastic film bands, when starting with the plastic band positioned closest to the display surface 124, are machined and engraved to form faceted multi-angle reflectors 502 that are associated with the imaging assembly 160. The multi-angle reflectors 500 define a series of highly reflective, generally planar mirror elements 500a that are angled to reflect light emitted by the IR light source 190 of imaging assembly 162 back towards the image sensor 170 of imaging assembly 162. Similarly, the multi-angle reflectors 502 define a series of highly reflective, generally planar mirror elements 502a that are angled to reflect light emitted by the IR light source 190 of imaging assembly 160 back towards the image sensor 170 of imaging assembly 160. By using an increased number of bands configured as multi-angle reflectors, the bezel segment 444 appears more evenly illuminated when viewed by the imaging devices 160 and 162.

FIG. 10C yet another bezel segment 544 comprising a backing having an inwardly directed surface that is generally normal to the plane of the display surface 124. Twelve plastic film bands positioned one above the other are disposed on the backing. The bands may be formed on a single plastic strip disposed on the backing or may be formed on individual strips disposed on the backing. In this embodiment, the odd plastic film bands, when starting with the plastic band positioned closest to the display surface 124, are machined and engraved to form faceted multi-angle reflectors 600 that are associated with the imaging assembly 162. The even plastic film bands, when starting with the plastic band positioned closest to the display surface 124, are machined and engraved to form faceted multi-angle reflectors 602 that are associated with the imaging assembly 160. The multi-angle reflectors 600 define a series of highly reflective, generally planar mirror elements 600a that are angled to reflect light emitted by the IR light source 190 of imaging assembly 162 back towards the image sensor 170 of imaging assembly 162. Similarly, the multi-angle reflectors 602 define a series of highly reflective, generally planar mirror elements 602a that are angled to reflect light emitted by the IR light source 190 of imaging assembly 160 back towards the image sensor 170 of imaging assembly 160.

FIGS. 10D and 10E show yet another bezel segment 644 comprising a backing having an inwardly directed surface that is generally normal to the plane of the display surface. In this embodiment, the bezel segment 644 comprises a single plastic band that is machined and engraved to provide two sets of generally planar mirror elements, with the mirror elements of the sets being alternately arranged along the length of the bezel segment 644. The mirror elements 650 of one set are angled to reflect light back towards the image sensor 170 of imaging assembly 160 and the mirror elements 652 of the other set are angled to reflect light back towards the image sensor 170 of imaging assembly 162.

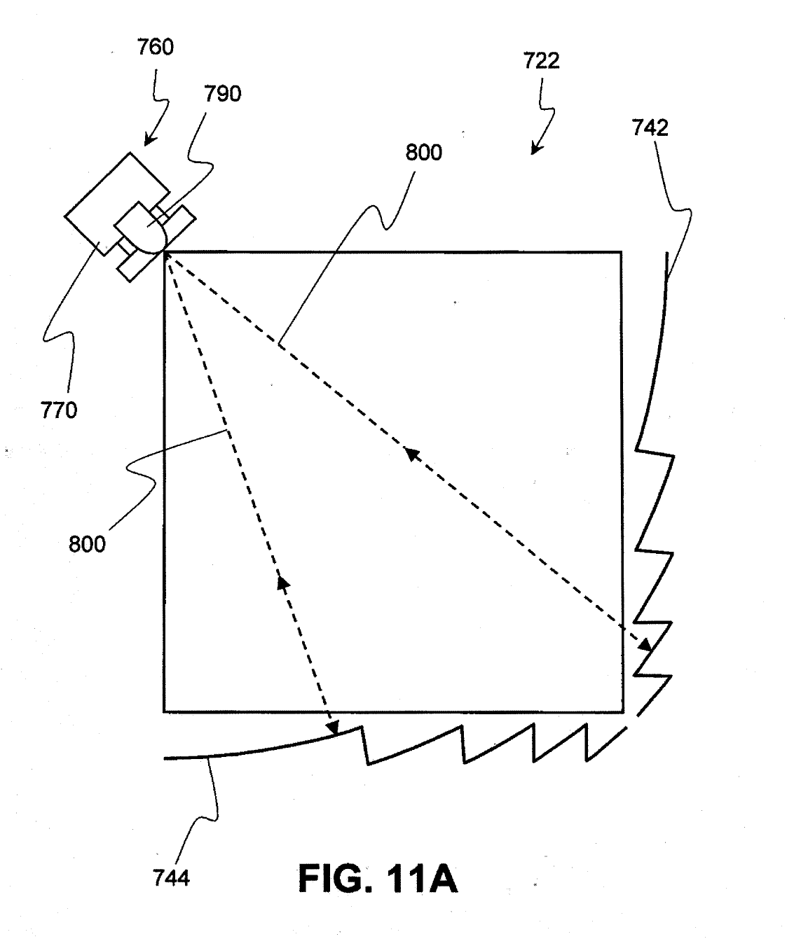

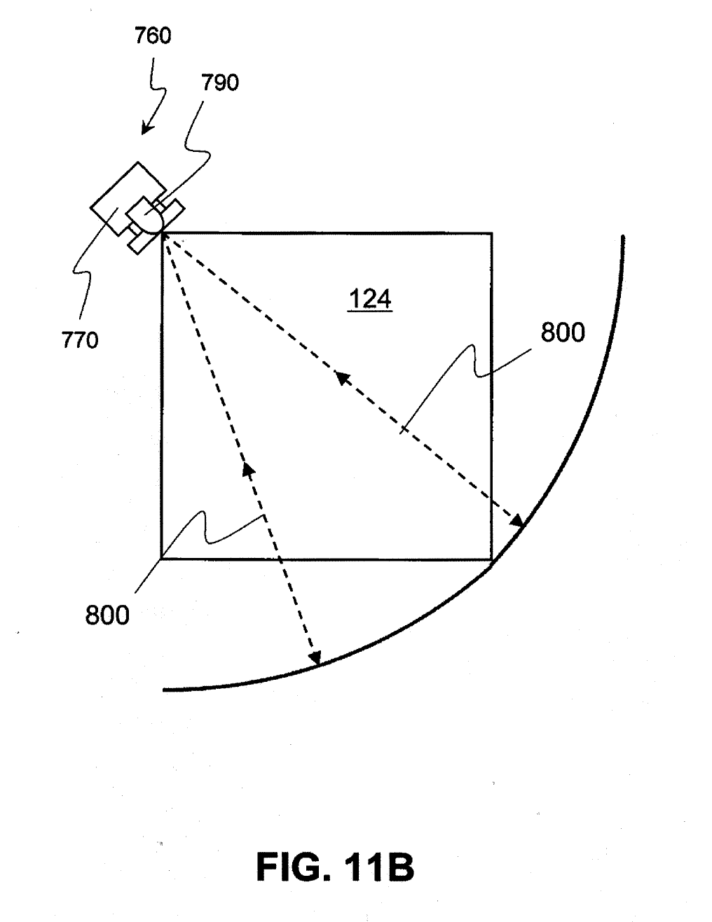

FIG. 11A shows an alternative assembly 722 for the interactive input system 100. Similar to the previous embodiment, the assembly comprises a frame assembly that is mechanically attached to the display unit and surrounds the display surface 124. Frame assembly comprises a bezel having two bezel segments 742 and 744. Bezel segment 742 extends along one side edge of the display surface 124 while bezel segment 744 extends along the bottom edge of the display surface 124. A single imaging assembly 760 is positioned adjacent the top left corner of the assembly 722 and is oriented so that its field of view looks generally across the entire display surface 124. The bezel segments 742 and 744 are oriented so that their inwardly facing surfaces are generally normal to the plane of the display surface 124. In this embodiment, the imaging assembly 160 sees both bezel segments 742 and 744.

Each bezel segment comprises a backing having an inwardly directed surface that is generally normal to the plane of the display surface 124. A machined and engraved plastic film is provided on the inwardly directed surface of each backing so that the plastic films define a highly reflective surface that mimics a curved mirror similar to that shown in FIG. 11B so that light emitted by the IR light source 790 of the imaging assembly 760 is reflected back towards the image sensor 770 of the imaging assembly 760 as indicated by the dotted lines 800. The profiles of the machined and engraved plastic films are based on the same principle as creating a Fresnel lens from a conventional plano-convex lens. Each plastic film can be thought of as a curved lens surface that has been divided into discrete, an offset lens element. The highly reflective surface is configured so that light emitted by the IR light source of the imaging assembly is reflected back towards the image sensor of the imaging assembly.

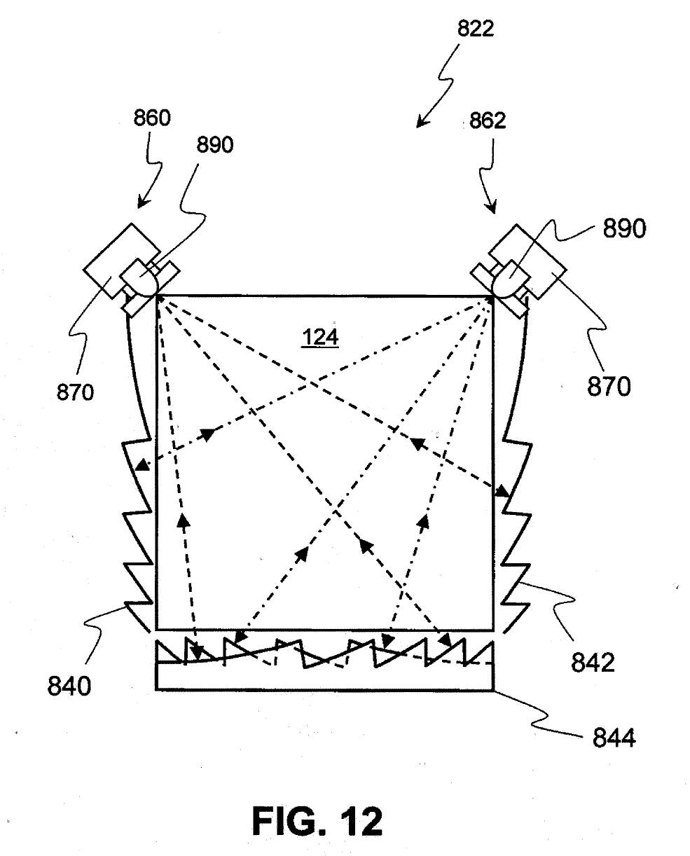

FIG. 12 shows yet another assembly 822 for the interactive input system 100. Similar to the first embodiment, the assembly comprises a frame assembly that is mechanically attached to the display unit and surrounds the display surface 124. Frame assembly comprises a bezel having three bezel segments 840, 842 and 844. Bezel segments 840 and 842 extend along opposite side edges of the display surface 124 while bezel segment 844 extends along the bottom edge of the display surface 124. Imaging assemblies 860 and 862 are positioned adjacent the top left and top right corners of the assembly 822 and are oriented so that their fields of view overlap and look generally across the entire display surface 124. The bezel segments 840, 842 and 844 are oriented so that their inwardly facing surfaces are generally normal to the plane of the display surface 124. In this embodiment, imaging assembly 860 sees bezel segments 842 and 844 and imaging assembly 862 sees bezel segments 840 and 844. Thus, the bottom bezel segment 844 is seen by both imaging assemblies 860 and 862 while the bezel segments 840 and 842 are only seen by one imaging assembly.

In this embodiment, the construction of the bezel segments 840 and 842 is the same as the first embodiment. The bezel segment 840 is a mirror image of bezel segment 842. As a result, the bezel segment 840 reflects light emitted by the IR light source 890 of the imaging assembly 862 back towards the image sensor 870 of the imaging assembly 862 and the bezel segment 842 reflects light emitted by the IR light source 890 of the imaging assembly 860 back towards the image sensor 870 of the imaging assembly 860. The plastic films of the bezel segments are similarly machined and engraved to form faceted multi-angle reflectors, each defining a series of highly reflective mirror elements extending the length of the bezel segment. The mirror elements in this embodiment however have a different configuration than in the previous embodiments. In particular, the sizes of the highly reflective mirror elements defined by the multi-angle reflectors vary over the length of the bezel segment, in this case decrease in a direction away from the imaging assembly that is proximate to the bezel segment.

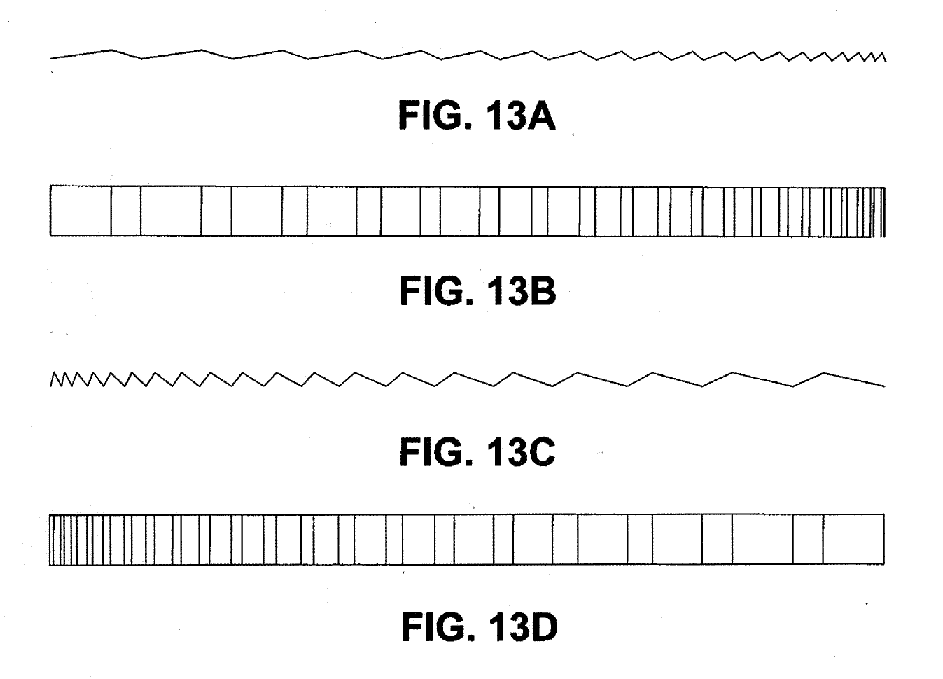

The construction of the bezel segment 844 is also the same as the first embodiment. As a result, the plastic band of the bezel segment 844 nearest the display surface reflects light emitted by the IR light source 890 of the imaging assembly 862 back towards the image sensor 870 of the imaging assembly 862 and the other plastic band of the bezel segment 844 reflects light emitted by the IR light source 890 of the imaging assembly 860 back towards the image sensor 870 of the imaging assembly 860. The plastic bands of the bezel segment 844 are similarly machined and engraved to form faceted multi-angle reflectors, each defining a series of highly reflective mirror elements extending the length of the bezel segment. The mirror elements in this embodiment however have a different configuration than in the previous embodiments. In particular, the sizes of the highly reflective mirror elements defined by the multi-angle reflectors decrease in a direction away from the imaging assembly to which the mirror elements reflect light as shown in FIGS. 13A to 13D.

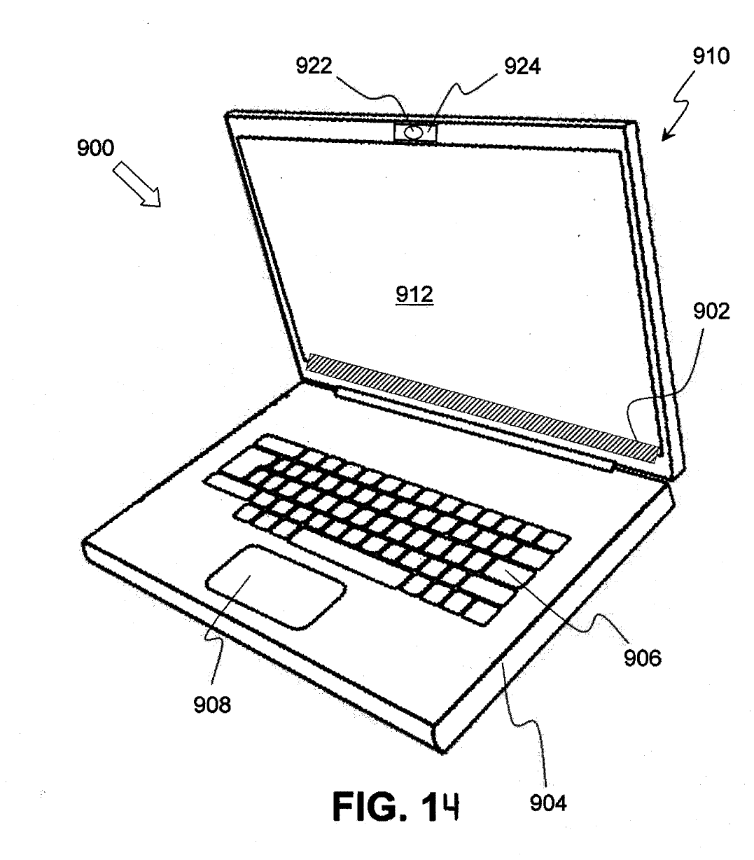

Turning now to FIG. 14, a laptop computer employing a faceted multi-angle reflector 902 is shown and is generally identified by reference numeral 900. As can be seen, the laptop computer 900 comprises a base component 904 that supports a keyboard 906 and a mouse pad 908 and that accommodates the laptop computer electronics and power supply. A lid component 910 that accommodates a liquid crystal display 912 is hingedly connected to the base component 904. The faceted multi-angle reflector 902 is supported by the lid component 910 and extends along the bottom edge of the display 912. A camera 922 having an associated light source is supported by the lid component 910 and is positioned adjacent the top center of the display 912. A prism 924 is positioned in front of the camera 922 to re-direct the field of view of the camera towards the multi-angle reflector 902. The field of view of the camera 922 is selected to encompass generally the entire display 912. Similar to the previous embodiments, the facets of the multi-angle reflector 902 define a series of highly reflective mirror elements that are angled to direct light emitted by the light source back towards the camera 922. In this manner, pointer contacts on the display 912 can be captured in image frames acquired by the camera 922 and processed by the laptop computer electronics allowing the display 912 to function as an interactive input surface. Of course those of skill in the art will appreciate that the multi-angle reflector may be used with the display of other computing devices such as for example, notebook computers, desktop computers, personal digital assistants (PDAs), tablet PCs, cellular telephones etc.

To reduce the amount of data to be processed, only the area of the image frames occupied by the bezel segments need be processed. A bezel finding procedure similar to that described in U.S. patent application Ser. No. 12/118,545 to Hansen et al. entitled “Interactive Input System and Bezel Therefor” filed on May 9, 2008 and assigned to SMART Technologies ULC of Calgary, Alberta, the content of which is incorporated herein by reference, may be employed to locate the bezel segments in captured image frames. Of course, those of skill in the art will appreciate that other suitable techniques may be employed to locate the bezel segments in captured image frames.

Although the frame assembly is described as being attached to the display unit, those of skill in the art will appreciate that the frame assembly may take other configurations. For example, the frame assembly may be integral with the bezel 38. If desired, the assemblies may comprise their own panels to overlie the display surface 124. In this case, it is preferred that the panel be formed of substantially transparent material so that the image presented on the display surface 124 is clearly visible through the panel. The assemblies can of course be used with a front or rear projection device and surround a substrate on which the computer-generated image is projected or can be used separate from a display device as an input device.

In the embodiments described above, the mirror elements of the faceted multi-angle reflectors are described as being generally planar. Those of skill in the art will appreciate that the mirror elements may take alternative configurations and the configuration of the mirror elements may vary along the length of the bezel segment. For example, rather than planar mirror elements, the mirror elements may present convex or concave surfaces towards the imaging assemblies.

Although the light sources of the imaging assemblies are described as comprising IR LEDs, those of skill in the art will appreciate that the imaging devices may include different IR light sources. The light sources of the imaging assemblies alternatively may comprise light sources that emit light at a frequency different than infrared. As will be appreciated using light sources that emit non-visible light is preferred to avoid the light emitted by the light sources from interfering with the images presented on the display surface 124. Also, although the light sources are shown as being located adjacent the imaging devices, alternative arrangements are possible. The light sources and imaging devices do not need to be positioned proximate one another. For example, a single light source positioned between the imaging devices may be used to illuminate the bezel segments.

Those of skill in the art will appreciate that although the imaging assemblies are described being positioned adjacent the top corners of the display surface and oriented to look generally across the display surface, the imaging assemblies may be located at other positions relative to the display surface 124.

Those of skill in the art will also appreciate that other processing structures could be used in place of the master controller and general purpose computing device. For example, the master controller could be eliminated and its processing functions could be performed by the general purpose computing device. Alternatively, the master controller could be configured to process the image frame data output by the image sensors both to detect the existence of a pointer in captured image frames and to triangulate the position of the pointer. Although the imaging assemblies and master controller are described as employing DSPs, other processors such as microcontrollers, central processing units (CPUs), graphics processing units (GPUs), or cell-processors could be used.

Although embodiments have been described, those of skill in the art will appreciate that other variations and modifications may be made without departing from the spirit and scope thereof as defined by the appended claims.

What is claimed is:

1. An interactive input system comprising:
at least one imaging device having a field of view looking into a region of interest;
at least one radiation source emitting radiation into said region of interest; and
a bezel at least partially surrounding said region of interest, said bezel comprising a multi-angle reflecting structure to reflect emitted radiation from said at least one radiation source towards said at least one imaging device.

2. An interactive input system according to claim 1 wherein said multi-angle reflecting structure comprises at least one series of reflective elements extending along the bezel, said reflective elements being configured to reflect emitted radiation from said at least one radiation source towards said at least one imaging device.

3. An interactive input system according to claim 1 wherein each reflective element is of a size smaller than the pixel resolution of said at least one imaging device.

4. An interactive input system according to claim 3 wherein each reflective element presents a reflective surface that is angled to reflect emitted radiation from said at least one radiation source towards said at least one imaging device.

5. An interactive input system according to claim 4 wherein each reflective surface is generally planar.

6. An interactive input system according to claim 4 wherein each reflective surface is generally convex.

7. An interactive input system according to claim 4 wherein each reflective surface is generally concave.

8. An interactive input system according to claim 4 wherein the configuration of the reflective surfaces varies over the length of said bezel.

9. An interactive input system according to claim 8 wherein each reflective surface has a configuration selected from the group consisting of: generally planar; generally convex; and generally concave.

10. An interactive input system according to claim 4 wherein said at least one radiation source is positioned adjacent said at least one imaging device.

11. An interactive input system according to claim 11 wherein said at least one radiation source emits non-visible radiation.

12. An interactive input system according to claim 11 wherein said non-visible radiation is infrared radiation.

13. An interactive input system according to claim 12 wherein said at least one radiation source comprises one or more infrared light emitting diodes.

14. An interactive input system according to claim 4 wherein said bezel comprises a backing and a film on said backing, said film being configured to form said multi-angle reflecting structure.

15. An interactive input system according to claim 14 wherein said film is machined and engraved to form said multi-angle reflecting structure.

16. An interactive input system according to claim 1 further comprising processing structure communicating with said at least one imaging device and processing image data output thereby to determine the location of a pointer within said region of interest.

17. An interactive input system according to claim 16 wherein said multi-angle reflecting structure comprises at least one series of reflective elements extending along bezel, said reflective elements being configured to reflect emitted radiation from said at least one radiation source towards said at least one imaging device.

18. An interactive input system according to claim 17 wherein each reflective element is of a size smaller than the pixel resolution of said at least one imaging devices.

19. An interactive input system according to claim 18 wherein each reflective element presents a reflective surface that is angled to reflect emitted radiation from said at least one radiation source towards said at least one imaging device.

20. An interactive input system according to claim 1 comprising at least two imaging devices, the imaging devices looking into the region of interest from different vantages and having overlapping fields of view, each section of the bezel seen by an imaging device comprising multi-angle reflecting structure to reflect emitted radiation from said at least one radiation source towards that imaging device.

21. An interactive input system according to claim 20 wherein each section of the bezel seen by more than one imaging device comprises a multi-angle reflecting structure for each imaging device, each at least one series of reflective elements extending along bezel.

22. An interactive input system according to claim 21 further comprising processing structure communicating with said at least two imaging devices and processing image data output thereby to determine the location of a pointer within said region of interest.

23. An interactive input system according to claim 21 wherein said region of interest is generally rectangular and wherein said bezel comprises a plurality of bezel segments, each bezel segment extending along a different side of said region of interest.

24. An interactive input system according to claim 23 wherein said bezel extends along three sides of said region of interest.

25. An interactive input system according to claim 24 comprising two imaging devices looking into said region of interest from different vantages and having overlapping fields of view, one of the bezel segments being visible to both imaging devices and each of the other bezel segments being visible to only one imaging device.

26. An interactive input system according to claim 25 further comprising processing structure communicating with said two imaging devices and processing image data output thereby to determine the location of a pointer within said region of interest.

27. An interactive input system according to claim 4 wherein said at least one radiation source is positioned remotely from said at least one imaging device.

28. A bezel for an interactive touch surface comprising a multi-angled reflector comprising at least one series of reflective surfaces extending along the bezel, each reflecting surface being oriented to reflect radiation toward at least one imaging device.

29. A bezel according to claim 28 wherein said multi-angle reflector comprises at least two generally parallel series of reflective surfaces, each series of reflecting surfaces being oriented to reflect radiation towards a different imaging device.
